(19) United States
(12) Patent Application Publication
(10) Pub. No.: US 2021/0407236 A1
(43) Pub. Date: Dec. 30, 2021

(54) METHOD FOR FACILITATING COLLECTION OF ITEMS WITHOUT HUMAN INTERACTION

(71) Applicant: SYNQ ACCESS + SECURITY TECHNOLOGY LTD., Victoria (CA)

(72) Inventors: Nolan WHEELER, Victoria (CA); Joshua RODRIGUEZ, Victoria (CA)

(21) Appl. No.: 17/362,445

(22) Filed: Jun. 29, 2021

(30) Foreign Application Priority Data
Jun. 30, 2020 (CA) 3085234

(51) Int. Cl. G07C 9/00; G07C 9/27; E05B 43/00

(52) U.S. Cl. CPC G07C 9/00896; E05B 43/005; G07C 9/00309; G07C 9/27

(57) ABSTRACT

A method for facilitating collection of items without human interaction involves providing a banks of compartments, with the bank of compartments having a plurality of individual compartments. The method involves instructing the customer to use a personal electronic device upon arrival to communicate with a server. The method involves programming the server to respond to communication from the customer by providing a temporary communication interface. Upon the customer providing information deemed necessary to the server via the temporary communication interface, the server directs the customer to a selected one of the plurality of individual compartments. Where theft is a concern, each of the individual compartments may have a door locked by an electronic lock controlled by the server.

### FIELD

There is described a method for facilitating collection of items without human interaction that was developed for retail store pickup, but has wider application.

### BACKGROUND

COVID-19 has caused a shift in focus in people when deciding to venture into public, to interact with other people, or to even touch certain things. Limiting the interaction with other people has taken on a new importance.

### SUMMARY

There is provided a method for facilitating collection of items without human interaction. The method involves providing a bank of compartments, with the bank of compartments having a plurality of individual compartments. The method involves instructing the customer to use a personal electronic device upon arrival to communicate with a server. The method involves programming the server to respond to communication from the customer by providing a temporary communication interface. Upon the customer providing information deemed necessary to the server via the temporary communication interface, the server directs the customer to the selected one of the plurality of individual compartments.

The method, as described above, is suitable for use in situations in which theft is not a major concern. Where theft is a concern, it is preferred that each of the individual compartments has a door locked by an electronic lock controlled by the server. Upon the customer providing the information deemed necessary to the server via the temporary communication interface, the server releases the electronic lock for the door of the selected one of the plurality of individual compartments.

Where a “touchless” experience is desired to avoid the need to sanitize the door after each use, a drive motor may be connected to the door of each of the individual compartments to move the door of the selected one of the plurality of individual compartments to an open position.

The method allows customers to collect items at their own convenience. This can be from retail stores, storage units in workplaces, mailboxes in high density residential environments, subways, bus stations, gyms, and high security environments where personal belongs are not allowed in.

Where a customer seeks to deposit an item for storage and later collection, the method involves a further step in which, after expiration of a predetermined time duration, the server is programmed to cause the door of the selected one of the plurality of individual compartments to be moved to a closed position by the drive motor and for the electronic lock to relock.

Notification that the customer or individual has arrived may be initiated by QR code, SMS, NFC, Web Application, or another medium of notification.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a flow diagram outline the sequence of the Method.

FIG. 2 a front elevation view of a bank of multiple storage units in accordance with the Method.

FIG. 3 a side elevation view, in section, of an interior of an individual compartment.

FIG. 4 top plan view of a personal electronic device.

FIG. 5 a front elevation view, in section, of the interior of an individual compartment with door open.

FIG. 6 a schematic drawing showing communication and control interface.

FIG. 7 is a flow diagram outline the sequence of a variant of the Method.

FIG. 8 a front elevation view of a bank of multiple storage units, in accordance with the variant of the Method.

### DETAILED DESCRIPTION

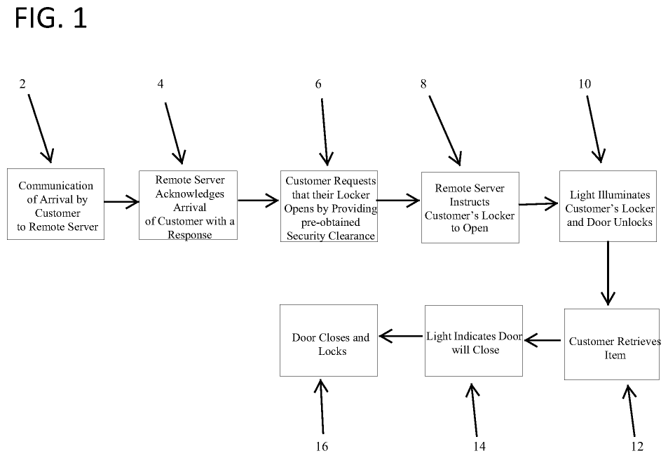

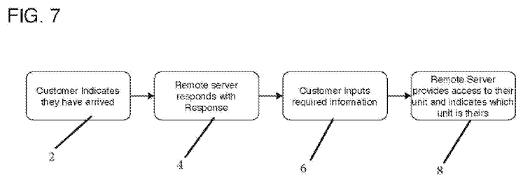

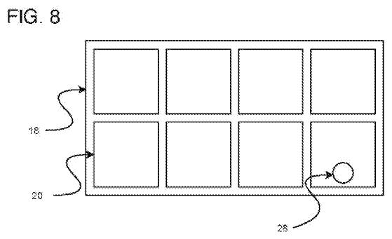

A method for facilitating collection of items without human interaction that was originally developed for retail store customer pick up will now be described with reference to FIG. 1 through FIG. 6. A simplified version of the method that was developed for coffee pick up will then be described with reference to FIG. 7 and FIG. 8.

Referring to FIG. 1, block 2, the customer or individual indicates that they have arrived, to the remote server. This may be accomplished via QR code for a web link, texting of a phone number, NFC, or another means. Referring to block 4, the remote server acknowledges that the customer or individual has arrived via a response. Referring to block 6, the customer or individual then requests that a compartment be opened as they provide any necessary security information to the system to authorize the system to provide access to the compartment. Referring to block 8, upon successful Authorization, the remote server then instructs the Compartment to open. Referring to block 10, the interior light of the compartment illuminates indicating to the customer or individual which compartment their items are contained in, the door unlocks and the door opens automatically. Referring to block 12, the customer then retrieves their item. Referring to block 14, the interior light indicates to the customer or individual that the compartment will begin to close. Referring to block 16, the door automatically closes and locks.

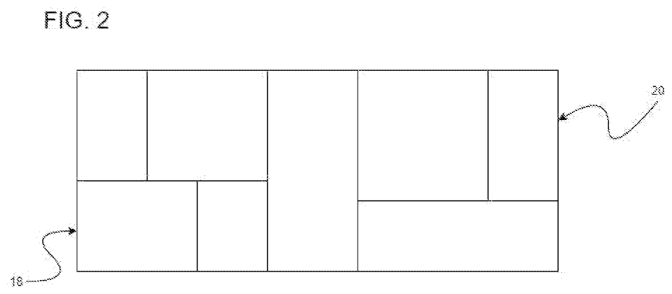

Referring to FIG. 2, a bank of compartments 18 is provided. Bank of compartments 18 consists of a plurality of individual compartments 20. Banks of compartments 18 is preferably modular. Individual compartments 20 can be either uniform in size of or consist of many different sizes.

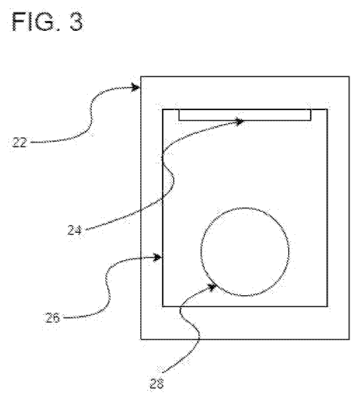

Referring to FIG. 3, each individual compartment 20 has a compartment door 22. An interior light 24 is mounted within compartment 20. Compartment door 22 may have a transparent or translucent panel 26 through which a customer may view an item 28 inside compartment 20 when interior light 24 is illuminated. Alternatively, the panel may be solid, and the interior light may be placed to be visible outside of the panel.

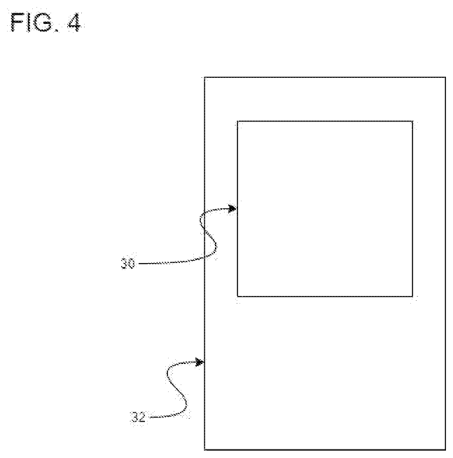

Referring to FIG. 4, a personal electronic device 32 is shown. Upon the customer communicating with the server via personal electronic device 32, a temporary communication interface 30 is provided to personal electronic device 32. Temporary communication interface 30 may be a link in a web browser, an application, or other temporary communication interface.

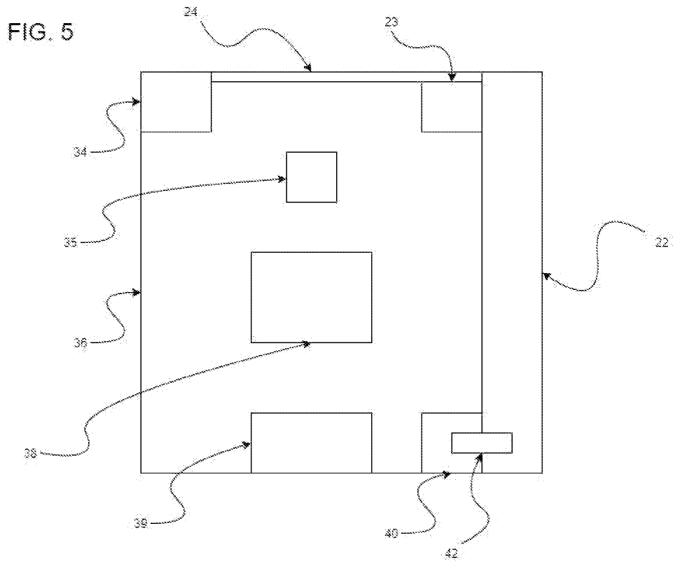

Referring to FIG. 5, compartment 36 is shown with its door in the open position revealing interior components. A locking mechanism 34 is mounted to the compartment 36. A communication interface module 38 is located at the rear of compartment 36 though the exact position is arbitrary. A motor 40 is provided which controls the opening and closing of compartment door 22. A linkage arm 42 connects motor 40 with compartment door 22. The interior light 24, as previously described, is mounted within compartment 36. Alternatively, if the compartment door 22 is solid, the interior light may be mounted in such a way that they are visible outside of the compartment 36. An optional camera 35 may be mounted within compartment 20. Camera 35 may be used for many tasks such as identifying the correct item has been placed in the compartment, the item has been removed, capturing an image of a person removing item 28, facial recognition, and others. An optional load cell 39 may be used to identify when item 28 has been removed from compartment 20. In a retail pick up application, load cell 39 can also identify if the wrong item is placed in the compartment, by determining a discrepancy between a weight of item 28 and a weight of the item purchased. An audio speaker 23 may be included for any audio needs such as remote support and audio queues. Other sensors may be included ultrasound, infrared, passive infrared, radar, and thermal.

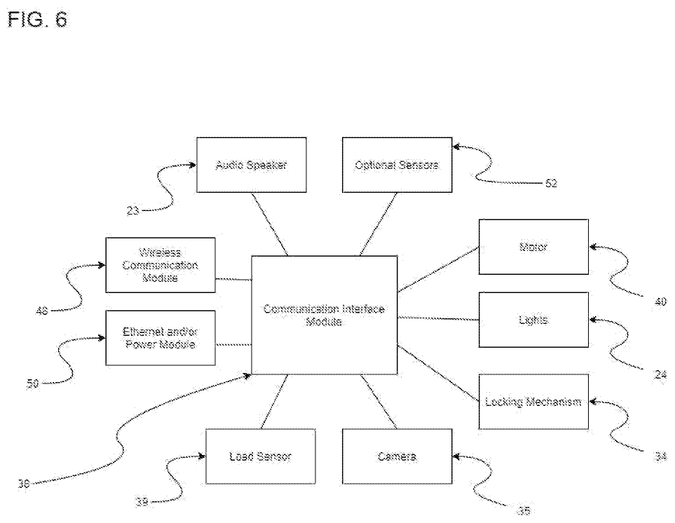

In order for all components of the system to function in a coordinated fashion, there must be communication between the various components and the server. Referring to FIG. 6, a schematic drawing of communication interface module 38 for the server is illustrated. Communication interface module 38 must have sufficient processing capabilities along with all requisite communication interfaces such as the wireless communication module 48 and the Ethernet and/or Power module 50 for any particular configuration. The communication interface module 38 is connected to the remote server initially mentioned in FIG. 1 via the wireless communication module 48, solely, or in combination with the Ethernet and/or power module 50. The components such as load cell 39, camera 35, audio speaker 23 and any other optional sensors 52 are provided here to give insight to non-limiting optional configurations. Wireless communication module 48 may consist of any or any combination of Wi-Fi, Bluetooth, NFC, LTE, or other radio communication protocol. 50 may provide power to the unit via power over Ethernet or a traditional wall plug.

The method described above facilitates collection of items without human interaction. If a touchless experience is desired to reduce the need for sanitation and reduce the likelihood of spreading COVID-19 or other communicable diseases, the method can be configured to automatically open and close the compartment door based on triggering events, such a predetermined time interval. The storage unit door is attached to an arm which is attached to a motor 40. This motor 40, extends and retracts the arm which causes the door to open and close without anyone physically touching the door. Due to the nature of the motor 40, controlling the door opening and closing, there is an inherent level of security provided by the motor. To increase security a locking mechanism 34, may be used in conjunction with the door. The locking mechanism 34, may be of physical, electromagnetic, or of another nature.

The storage unit may have a door that is opaque, translucent or clear. This allows for aesthetic considerations to be had as well as security. The storage unit may also have interior and/or exterior lighting. The storage unit may be made from any material to provide different characteristics to the storage unit. The storage unit may have one or more doors with one or more motors per door or it may have a single motor that controls all doors.

The storage unit may also have cameras covering the interior and/or exterior for facial recognition, security, or any other use a camera would be considered for. Access to the compartment may include facial recognition of other biometrics such as, but not limited to, fingerprints. The storage unit may also use NFC technology to grant access. The storage unit may have other sensors within it such as temperature, humidity, load, etc. This allows for better security, a guarantee that items remained in an appropriate environment, and other advanced capabilities dependant on which sensors are included in any given configuration of the storage unit. It is also conceivable that the storage unit have integrated, or be coupled with, advanced detectors such as Mass Spectrometers, Gas Chromatographs, or other advanced detection devices which could detect unsafe materials in the storage unit and provide advanced warning.

The motor 40, is controlled by a communication interface module 38, which processes signals that determine when the door should open and when the door should close. Any included sensors are also connected to this controlling unit 38, either wired or wirelessly. The communication interface module 38, also has means to connect to the internet through one or more Ethernet connections or wirelessly over its one or more Wi-Fi, Satellite, LTE, 5G, Bluetooth, or other Radio communication interfaces. The storage unit may get its power over one or more Ethernet cables via PoE and/or it may get power by a conventional power outlet.

The storage unit opens and closes as indicated by the communication interface module 38. The communication interface module38, may control one or more storage units. It may also communicate with other communication interface modules 38.

The storage unit does not have restrictions on how large or small it may be. It is of a highly modular nature which allows for it to be placed as a standalone storage unit or to be a part of a large bank of storage units. Since the storage unit can be of any given size, the bank which it may be integrated into may have storage units of all sizes, allowing for a range of storage capabilities.

Variation:

The variant illustrated in FIG. 7 and FIG. 8 was developed for use where fear of theft is not a problem, but there is still a desire to limit one's interaction with other people. For example, it is now possible to order coffee or a fast-food take-out meal on one's phone. However, one still must interact with staff to pick up your coffee or take-out meal. The present method can be used in such cases, to expedite the collection of the coffee or take-out meal without any interaction with other people.

Referring to FIG. 7, block 2, the customer or individual indicates that they have arrived, to the remote server. This may be accomplished via QR code for a web link, texting of a phone number, NFC, or another means. Referring to block 4, the remote server acknowledges that the customer or individual has arrived via a response. Referring to block 6, the customer or individual provides any necessary security information to the system. Referring to block 8, upon successful authorization, the remote server then instructs the customer on the compartment from which their coffee or take-out meal can be collected.

Referring to FIG. 8, a bank of compartments 18 is provided. Bank of compartments 18 consists of a plurality of individual compartments 20. Bank of compartments 18 is preferably modular. Individual compartments 20 can be either uniform in size of or consist of many different sizes. Item 28, is placed in the selected one of the individual compartments 20, to await pickup. Compartments can be identified by numbers, letters, or lights that are activated by the server as previously described.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method for facilitating collection of items without human interaction, comprising:
providing a bank of compartments, the bank of compartments having a plurality of individual compartments;
instructing the customer to use a personal electronic device upon arrival to communicate with a server;
programming the server to respond to communication from the customer by providing a temporary communication interface;
upon the customer providing information deemed necessary to the server via the temporary communication interface, the server directs the customer to a selected one of the plurality of individual compartments.

2. The method of claim 1, wherein each of the individual compartments has a door locked by an electronic lock controlled by the server and, upon the customer providing the information deemed necessary to the server via the temporary communication interface, the server releases the electronic lock for the door of a selected one of the plurality of individual compartments.

3. The method of claim 2, wherein a drive motor is connected to the door of each of the individual compartments to move the door of the selected one of the plurality of individual compartments to an open position.

4. The method of claim 3, wherein, after expiration of a predetermined event, the server is programmed to cause the door of the selected one of the plurality of individual compartments to be moved to a closed position by the drive motor and for the electronic lock to relock.

5. The method of claim 1, wherein the communication upon arrival is initiated by SMS.

6. The method of claim 1, wherein the communication upon arrival is initiated by NFC.

7. The method of claim 1, wherein the communication upon arrival is initiated by scanning a QR code.

8. The method of claim 3, wherein an interior light located within the selected one of the plurality of compartments pulsates or uses colour change to indicate the opening of the door.

9. The method in claim 4, wherein an interior light located within the selected one of the plurality of compartments slowly dims or uses colour change to indicate that the door will close.

10. The method of claim 4, wherein a timer is activated upon the opening of the door and the server is programmed to close the door after a predetermined time duration.
